(19) United States
(12) Patent Application Publication
(10) Pub. No.: US 2007/0156942 A1
(43) Pub. Date: Jul. 5, 2007

(54) Method and apparatus for independently managing a chipset-integrated bus controller

(76) Inventor: Robert Gough, Cornelius, OR (US)

Correspondence Address: INTEL CORPORATION;c/o INTELLEVATE, LLC, P.O. BOX 52050, MINNEAPOLIS, MN, 55402, US

(21) Appl. No.: 11/322,682

(22) Filed: Dec. 30, 2005

(51) Int. Cl. G06F 13/00

(52) U.S. Cl. 710/302

(57) ABSTRACT

A method and apparatus is described herein are for managing interconnect controllers. When a downstream device is removed from a system, the controller coupled to the devce is placed in a low-power state to save power and ejected from an operating system. Detection circuitry in the controller is also disabled. However, periodically the circuitry is re-enabled to determine if a downstream device has been connected. Upon insertion, the controller is powered on and enabled in the operating system.

### FIELD

This invention relates to the field of power management on integrated circuits and, in particular, to managing interconnect controllers.

### BACKGROUND

Computer systems have quickly become the center of numerous operations performed in households throughout the world. Previously, a computer was used only for computing operations; however, uses for computers have progressed from this simple model into an electronics hub. A few examples of this progression include using a computer as a media center, a TV, a stereo, and a picture repository. As a result, the number of devices that are connected to a computer continue to increase daily, from internal components, such as audio device, network adapters, and video controllers, to external components such as portable storage devices, cameras, and audio/video equipment.

As a consequence, the interconnect structure to ensure compatibility with all of the aforementioned devices has become increasingly complex. Examples of current interconnects include Peripheral Component Interconnect (PCI), PCI Express (PCI-E), Universal Serial Bus (USB), Serial Advanced Technology Attachment (SATA) interconnect, Interconnect Controller Hub (ICH) interconnect, Hublink, IEEE-1394 (Firewire), as well as numerous others.

To provide maximum flexibility in the connection of devices to a computer system, often a system supports removal or addition of a device during operation, which is often referred to as hot plug/swap. Hot plug allows for users to plug in a camera, portable storabe device, or other device without having to shutdown the computer and wait for it to rebot. Software tools in operating systems, such as plug-and-play (PnP) managers have been developed to enable a hot swap concept. Therefore, upon removal/addition of a device, a PnP manager is tasked with removing/adding the devce from an operating system's perspective. Yet, when a device is removed, only the device is typically removed from view of the operating system (OS). Furthermore, to ensure a device is reconized upon reconnection to the system, the bus controller used to communicate with the devce is left power on, which results in power in power loss and leakage.

### BRIEF DESCRIPTION OF THE DRAWINGS

The present invention is illustrated by way of example and not intended to be limited by the figures of the accompanying drawings.

FIG. 1 illustrates an embodiment of a controller hub including a controller coupled to a device.

FIG. 2 illustrates an embodiment of layered abstraction of hardware including a controller hub and a device, and software including a handler and virtual machines.

FIG. 3 illustrates an embodiment of a system including device coupled to a chipset coupled through an interconnect.

FIG. 4a illustrates an embodiment of a flow diagram for detecting removal of a device and requesting removal of a controller and power to the controller.

FIG. 4b illustrates an embodiment of a flow diagram for disabling a controller upon removal of a device.

FIG. 5a illustrates an embodiment of a flow diagram for periodically enabling a detection module to detect a device and to enable a controller if a device is detected.

FIG. 5b illustrates an embodiment of a flow diagram for enabling a controller upon detecting insertion of a device.

### DETAILED DESCRIPTION

In the following description, numerous specific details are set forth such as examples of interconnects, devices, controllers, software storage, implementation, etc. in order to provide a thorough understanding of the present invention. It will be apparent, however, to one skilled in the art that these specific details need not be employed to practice the present invention. In other instances, well known components or methods, such as specific interconnect implementation, logic and circuit implementations, interrupt handlers, as well as code for operating systems, basic input/output software (BIOS), and handler routines, have not been described in detail in order to avoid unnecessarily obscuring the present invention.

The method and apparatus described herein are for managing interconnect controllers, which is specifically discussed in reference to interconnect controllers in a computer system. However, the methods and apparatus for managing interconnect controllers are not so limited, as they may be implemented on or in association with any system or integrated circuit device, such as a portable digital assistant (PDA), cell phone, or other electronic device.

Controller Hub

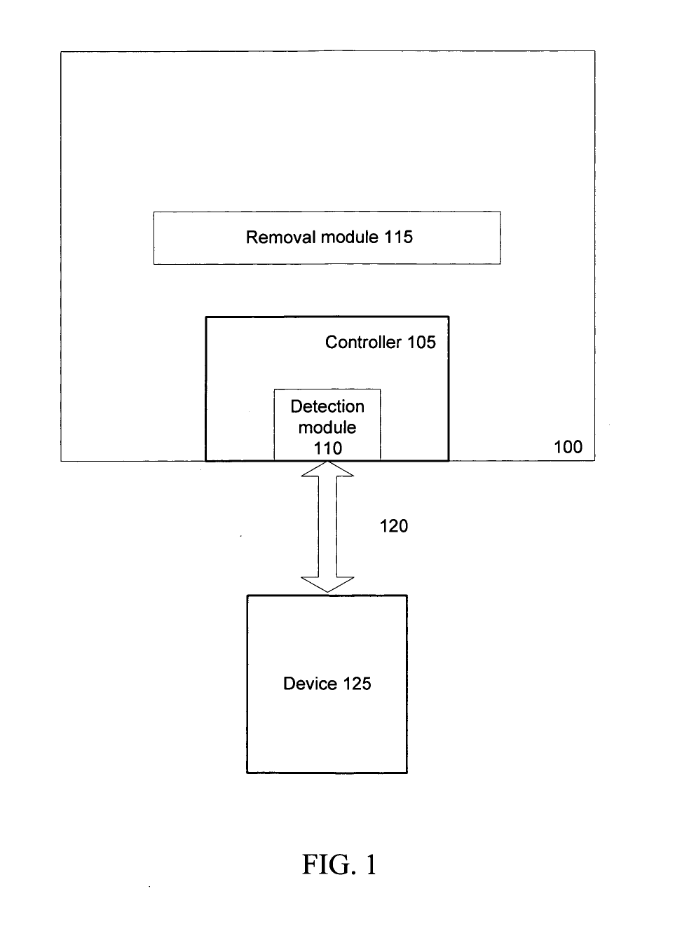

Referring to FIG. 1, controller hub 100 is illustrated. Controller hub 100 may be any integrated circuit or programmable device, such as a Field Programmable Gate Array (FPGA). In one embodiment, controller hub 100 is a hub in a computer system to couple interconnect devices too. As an example, controller hub 100 is a interconnect controller hub (ICH) coupled to a memory controller hub (MCH), where ICH 100 is to communicate with the MCH, as well as other devices. Commonly, a combination of the MCH and ICH are referred to as a chipset, which is typically implemented on at least two different integrated circuits.

Devices coupled to hub 100 are not limited to devices internal to a computer system, as devices external to the system may also be coupled to hub 100. As examples, controller hub 100 couples to network adapters/devices, local area network (LAN) devices, audio devices, video processors/devices, storage devices, disk drives, hard drives, portable storage devices, input/output devices, cameras, personal digital assistances, display devices, printers, phones, wireless devices, faxes, and other electronic devices. As noted above, coupling is not limited to physical coupling, as wireless devices may communicate with a transmitter/receiver integrated in controller hub 100 or physically coupled to controller hub 100.

Controller

Controller 105 is illustrated in controller hub 100. However, from above it is also apparent that controllers or devices, such as a local area network device/controller, may be coupled externally to controller hub 100 or integrated in controller hub 100. In one embodiment, controller 105 includes logic to communicate with a device. As an illustrative example, controller 105 is a network controller to communicate with a network adapter device. In this example, assume a packet of information is received by the network adapter from an external network, such as the internet. This packet is then communicated to controller 105, and either decoded or forwarded by controller 105 to the correct destination.

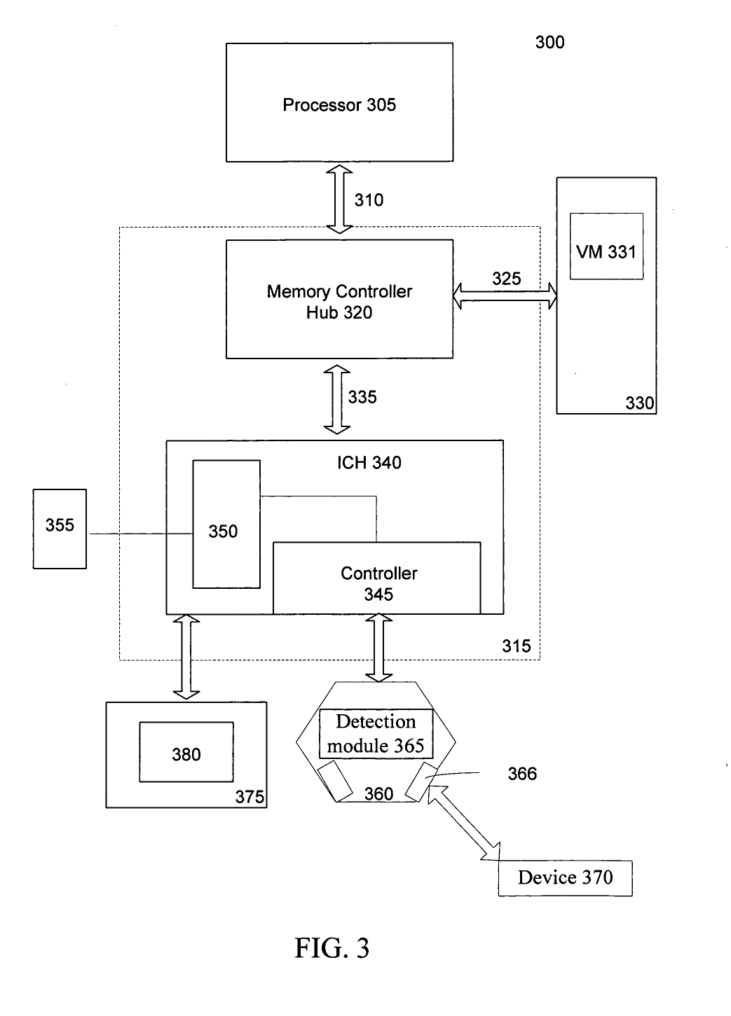

As discussed later in reference to FIG. 3, a root controller is typically a controller at the highest level in a hierarchy of an interconnect. Yet, a root controller or controller 105 may be integrated in controller hub 100 or external to controller hub 100. In addition, controller 105 includes any logic, circuits, software, hardware, or code for communicating with other devices in a system. Other examples of controller 105 include a peripheral connection interconnect (PCI) bus controller, a PCI express (PCI-E) bus controller, a universal serial bus controller, a disk controller, a long-term storage device controller, an ATA disk controller, a SCSI controller, a firewire controller, an audio controller, a video controller, a graphics controller, a network controller, a local area network (LAN) controller, a memory interface controller, front-side bus (FSB) controller, a serial interface controller, a parallel interface controller, and an interconnect controller, or any combination controller implementing tow or more types of interfaces, such as audio/video output/input.

Devices

Device 125 is illustrated coupled to controller 105. As stated above, device 125 includes any device commonly or potentially associated with coupling to an electronic or computer system. In a first embodiment, device 125 is an internal device in the system. The following are illustrative examples of devices typically found in a computer system: graphics cards, audio cards, network cards, hard-drives, disk-drives, storage-drives, CD/DVD ROMS, and other cards in peripheral connection interconnect (PCI) or PCI-Express (PCI-E) slots. In another embodiment, device 125 is a device externally coupled to controller hub 100. Examples of external devices include monitors, printers, mice, keyboards, routers, speakers, portable storage devices, firewire device, Universal Serial Bus (USB) devices, faxes, phones, scanners, and other input/output devices. Note that any of the aforementioned devices may also be wirelessly coupled to controller hub 100.

Other specific examples of potential devices include a peripheral connection interconnect (PCI) device, a PCI express (PCI-E) device, a universal serial bus device, a storage drive, a permanent storage device, an ATA storage device, a SCSI device, a firewire device, an audio device, a video device, a graphics device, a network device, a LAN device, a memory device, and an interconnect device

Often an interconnect is logically or physically viewable and/or enumerable in a hierarchy. For example, a controller is coupled to a bridge device, which is coupled to two other devices. In this example, the two devices coupled to the bridge are at the same physical level in a hierarchy, as any signal sent to the controller goes through the bridge device and to the controller. Conversely, in a ring formation no true physical hierarchy is typically ascertainable; yet, a root device that initiates communication on the ring is logically viewable as being at the highest level of a hierarchy, with every other device down a level for each device it is removed from the root device.

As used herein, the term upstream, refers to a direction up the hierarchy of connection, i.e. towards a primary or root controller. In most cases, the highest level is viewed from the perspective of coupling to the rest of system. For example, assuming controller 100 is an ICH, then controller 105 in ICH 100 is at the highest level, as any communications from device 125 are sent through controller 105 to the rest of the system Inversely, downstream, as used herein, refers to a direction down the hierarchy of coupling, i.e. away from a primary or root controller. From the example above, it is apparent that device 125 is downstream from controller 105, as it is away from the highest level of the hierarchy. Note that there may also be sideband communication channels between device 125 and other devices within or connected to hub 100 that bypass controller 105.

Turning quickly to FIG. 3, a simplified example is shown, which further illustrates these principles. As an example, assume that device 370 is a USB mouse. To send a signal to the system, mouse 370 forwards the signal upstream to bridge 360, which in turn forwards the signal upstream to controller 345 in ICH 340. Therefore, it is apparent that mouse 370 is coupled downstream from both controller 345 and bridge 360.

Detection Module

Returning to FIG. 1, detection module 110 is illustrated in controller 105. In other embodiments, detection module 110 is external to controller 105, external to controller hub 100, or transcends the boundaries of any combination of controller 105, controller hub 100, and other hardware or software in a system. A module may be implemented in hardware, software, firmware, or any combination thereof. Commonly, module boundaries vary and functions are implemented together, as well as separately in different embodiments. As an example, which is discussed in more detail below, detection module 110 includes detection hardware/circuitry to detect if a device is present downstream from controller 105, and sends an event to firmware or software to notify an operating system that a device is added/removed, such that a plug-n-play manager to detect and enumerate devices beneath or remove controller 105 from view of an operating system.

Determining if a device is present downstream includes a number of potential variations. In one embodiment, a device is present downstream when a device is physically coupled downstream from a controller or controller hub. For example, assume that the controller is a PCI-E controller having a bridge, i.e. a video adapter, coupled to the controller and a video device, i.e. a monitor, coupled to the bridge. In this example, following the hierarchical structure, the PCI-E controller is at the highest level, the video adapter is at the next level, and the monitor is at the lowest level, which is downstream from the controller. In this instance a monitor is coupled downstream from the controller, and is, therefore, present. Moreover, if the device is physically removed from the system, the video device is no longer “present.”

However, “presence” of a device downstream from a controller is not so limited. In fact, in another embodiment, a device is not present, even if it is physically present and coupled downstream from the controller, if the device is inactive or virtually removed from the system. In an example, assume the a removable storage device is coupled to a Universal Serial Bus bridge. However, in this situation a user has gracefully requested removal of the storage device, which includes a request or virtual removal of the device from the perspective/view of an operating system (OS). Here, the device is still physically coupled to the PCI-E controller, but is not present, as the device is virtually removed. Additionally, a device may be physically coupled to the controller, but not present due to inactivity. In this case, hardware, software, firmware, or a combination thereof in the controller or device detects a level of inactivity and it determined to not be present after a certain amount on inactivity.

In one embodiment, detection module 110 includes circuitry or logic in controller 105 to detect if a device is present downstream from controller 105. As an example, detection circuitry includes a circuit to periodically send a signal, such as a ping signal, to determine if a device is present downstream. As a first example, the signal is a general broadcast signal to any devices downstream from the controller. Alternatively, a signal is sent to the address space of a device that was previously determined to be present downstream, to elicit a reply from the device. Interfaces, such as USB, firewire, PCI-E, as well as other interfaces mentioned above have common techniques for determining if a device is present, and any of those techniques may be used. Although the examples above, discuss periodic or synchronous detection of presence of an event, asynchronous events may also be used to detect or determine if a device is present. For example, the removal of a device initiates a signal, message, or interrup to be received by detection module 110 to represent that the device has been removed and is no longer present. Conversely, a similar event is generated upon installing a new device.

In contrast, the circuitry or logic may also be external to controller 105 or controller hub 100. As an example, a bridge device coupled between controller 105 and device 125 includes the logic to ping device 125 to see if device 125 is present. Where the logic to detect if a device is present is external to controller 105, detection module 110 or controller 105 includes circuitry/logic to receive a signal from the external circuit to represent whether or not a device is present.

Virtual removal includes removal of the device from the view of a user-level program such as an operating system, which may be done at the request of a user or by initiation of the hardware, software, or operating system. Therefore, detection module 110 may include an interrupt generation module, a handler module, an operating system (OS) device manager, such as a Plug-n-Play manager, or any combination thereof. These modules are discussed in more detail in the removal module section below.

User-Level Program

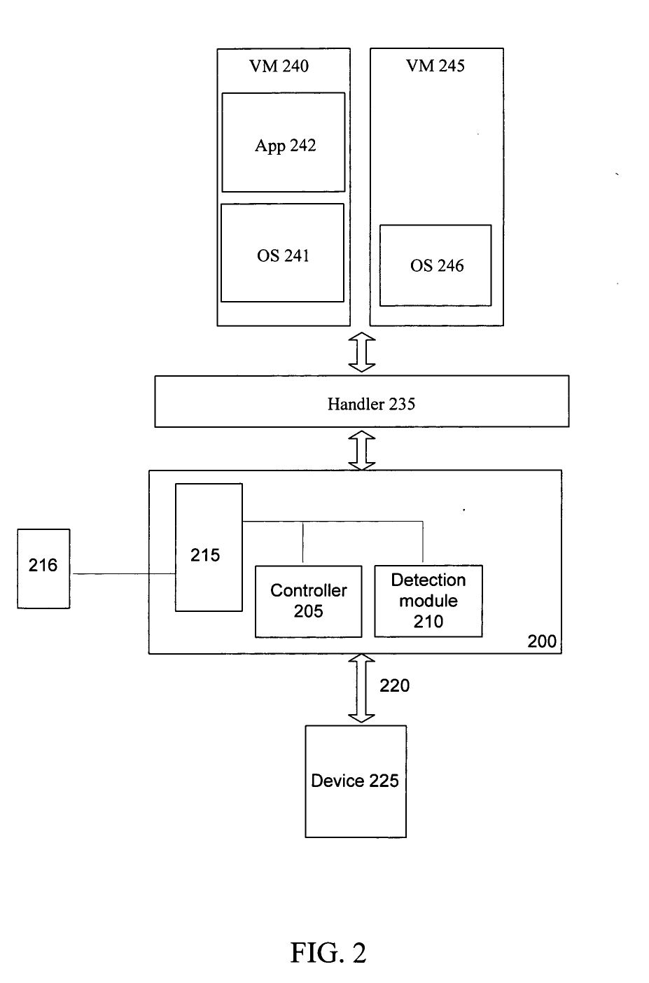

Turning to FIG. 2, a user-level program includes any program accessible at a user-level, where a device, such as device 225 is potentially viewable. In a first embodiment, a user-level program is an operating system, control path, or kernel. In addition, it is common in computer systems today to include virtualization and security. A virtual machine (VM), such as VM 240 and VM 245 are, typically dedicated a portion of memory. Consequently, multiple guest/user applications may run in separate virtual machines, i.e. separated portions of memory. This results in the ability of a platform to run multiple operating systems, as well as multiple applications within the memory space of each operating system. As an example, FIG. 2 illustrates two operating system instances, OS 241 and OS 246, with application 242 executing on operating system 241 in VM 240.

Usually in a secured environment, such as a virtual environment, a monitor is used to interface between the virtual machines and hardware the virtual machines share in the system. A virtual monitor includes any operation mode of a processor and/or management program for detecting and or handling system events, such as system management interrupts, commands, or ordinals. Examples of virtual monitors include system management mode (SMM), SMI transfer monitor (STM), and virtual machine monitor (VMM). In one embodiment, handler 235 is a virtual monitor, as discussed below in the removal module section. Also, since a virtual monitor typically interfaces with hardware, the virtual monitor may also be considered the user-level program to have devices/controllers removed from.

Removal Module

Turning to FIG. 2 an embodiment of a layered abstraction of hardware and software to remove a controller or device is illustrated. As shown, device 225 is coupled downstream from controller hub 200. Controller hub 200 includes controller 205, detection module 210, and removal module 215. Controller 205 and device 225 include any of the aforementioned interface controllers and system devices discussed above. As illustrated here, detection module 210 is external to controller 205 and internal to controller hub 200. However, as stated above detection module 210 may be in controller 205, external to controller hub 200, or vary across the boundaries of controller 205, controller hub 200, and external devices. In addition, controller 205 may be external to controller hub 200 and is not required to be at the highest level of hierarchy within an interface. For example, controller 205 is a bridge device that is more than one bridge or device removed from a root controller or controller hub 200.

After detecting removal of a device downstream from a controller, removal module 215 requests removal of controller 205. Note that removal of controller 205 may be selective. For instance, if one device coupled to controller 205 is removed, but another active device is present downstream, controller 205 is potentially not removed to ensure communication still occurs with the remaining active device. In one embodiment requesting removal of controller 205 includes generating a disconnect signal. A disconnect signal may include an interrupt, such as a System Control Interrupt (SCI) or any other synchronous or asynchronous signal/message to represent a request to remove controller 205.

As an example, assume that controller 205 is a USB controller and device 225 is an external portable storage device. When portable storage device 225 is removed, detection module 210 detects that device 225 is no longer present downstream from controller 205. As a result, a disconnect signal, such as a disconnect SCI is generated, either by detection module 210 or removal module 215, as both modules may be implemented across the boundaries of the other. As discussed below in more detail, the SCI is handled by handler module 235 and the device is removed from a user-level program, such as OS 241.

In another embodiment, requesting removal of controller 205 includes notifying a device manager for a user-level program, such as a plug-and-play (PnP) manager in OS 246 that controller 205 is to be removed, ejected, or stopped. In a very similar first example, an interrupt driven notification is used. However, any method for notifying a device manger may be used. After receiving the request, the manager ejects the controller just as any other device would be ejected or swapped during a hot swap event.

As stated above, in an interrupt based system, handler module 235 is to receive the disconnect signal or interrupt and either effect ejection of controller 205 or request ejection of controller 205 from a user-level program. In one embodiment, handler module 235 includes code stored in a non-volatile memory device. Specifically, the code is basic input/output software (BIOS) code and the non-volatile memory is a flash memory device, such as a NOR flash device. Here, an interrupt is generated, as stated above, to represent/request removal of controller 205. A similar removal method is accomplished for device 225, which may occur before or after the removal of controller 205 from a user-level program. Code executed in flash includes handler code to intercept the interrupt. The routines within the handler determine how the interrupt is handled to remove controller 205. As an example, the handler notifies a user-level program, such as an operating system, that the device has been removed, which essentially encompasses requesting the device to be removed from the user-level program.

In another embodiment, handler module 235 includes a virtual monitor, as discussed above. Here, upon new installation or removal of a device, an interrupt or disconnect signal is generated. Yet, in this case the interrupt targets a virtual monitor memory space associated with handler 235. Similar to a virtual monitor handling hardware interrupts in a virtualization environment, the virtual machine monitor (VMM) handles the detection of a newly installed or removed device. As a consequence, the VMM notifies/requests an OS, such as OS 241, that the device is to be added or removed, accordingly. Note that in a virtual environment or other environment where multiple operating systems or applications are being executed, controller 205 may be selectively removed from one OS, such as OS 241, but remain visible in OS 246, if the only device present downstream from controller 205 is associated with VM 245 and OS 246. Other well-known handler routines or equivalents to interrupt generating systems may be used to notify/request and operating system to remove controller 205.

In addition to requesting removal of controller 205 removal module 215 may also remove power from controller 205. In one embodiment, removal module 215 is referred to as a power module, when power is removed or reduced to controller 205. Removing of power or reducing of power to controller 205 is also referred to as placing or requesting controller 205 to enter a low-power state. Often, an integrated circuit or portions of thereof, are reduced to a lower power consumption state. For example, controller 205 operates in three different power states. A first power state is a full power state. A second state is a low power state, where less power is supplied to controller 205 or full-power is only supplied to portions of controller 205, such as detection module 110 in controller 105 in FIG. 1. The third power state is a complete unpowered state, where all power is removed from controller 205.

In a first embodiment, all power to controller 205 is removed, when controller 205 is removed or requested to be removed from an operating system. Here, a power source, such as power source 216, supplies power to controller hub 200, which in turn supplies power to controller 205 through a power distribution network. Therefore, upon a request or based on an interrupt removal module 215 gates all power supplied to controller 205. This results in potential power savings when the controller is removed from an OS, such as OS 241, and is not in use. In another example, removing all power not only includes removing power supplied to controller 205, but also gating, halting, or removing clocks supplied in a similar manner. Note from above, that controller 205 may also include detection module 210. Therefore, in another embodiment, removing all power from controller 205 includes removing power from a detection module, such as detection module 110 illustrated in FIG. 1.

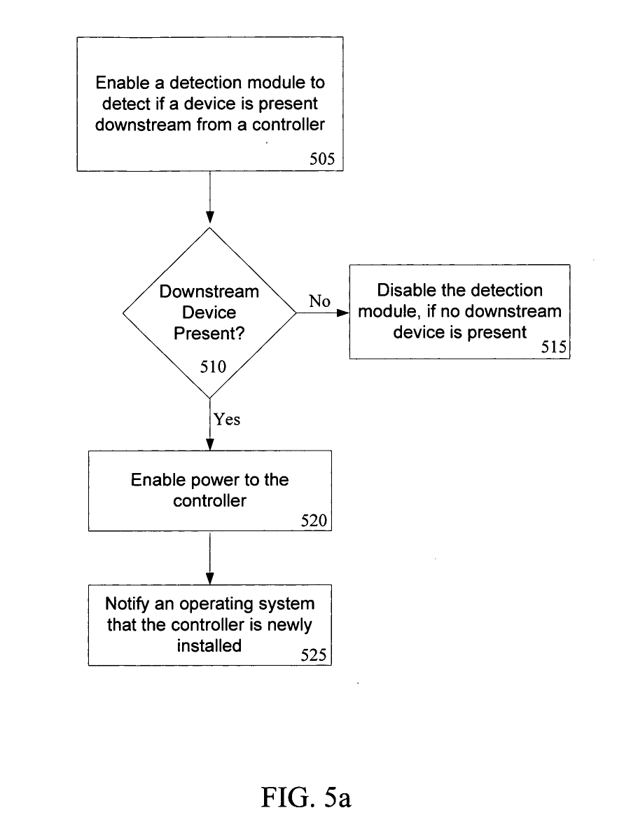

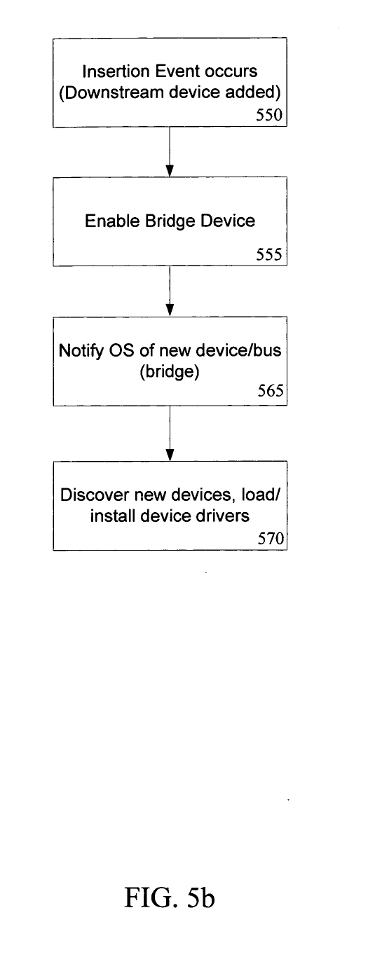

In another embodiment, controller 205 is requested or enters a low-power state where power is removed from controller 205, but power is still supplied to detection module 210, whether or not detection module is located internal or external to controller 205. In this case, detection module 210 retains power to determine if a new device is connected or installed, while the rest of controller 205 is powered off to conserve power. In another example, power supplied to detection module 210 is removed and periodically supplied to check if a new device has been removed. Here, power is removed from detection module 210 to save power during non-use; however, power is turned on occasionally to ensure no new devices have been connected. This example is discussed in more detail in reference to FIG. 5a.

As stated above, power module 215 removes power either based on a disconnect signal, a request to put controller 205 in a low-power state, or other power removal detection logic. As a first example, handler module 235, upon servicing the disconnect SCI, initiates a request or interrupt for power module 215 to remove power from controller 205. In another embodiment, upon removal of controller 205 in a user-level application, the user-level application requests that the controller be put in a low-power state. Therefore, the ultimate removal of power, reduction in power, and/or placing of controller 205 in a low-power state is typically based on detection of device 225 being removed and a request, such as an interrupt, to remove controller 205 being generated.

### AN EMBODIMENT OF A SYSTEM

Referring next to FIG. 3, an embodiment of a system including a interconnect controller hub having a detection module, a power module, and a removal module is illustrated. System 300 includes a processor 305 coupled to memory controller hub (MCH) 320, which is illustrated as part of chipset 315. Processor 305 is any processing element to operate on data or execute instructions, such as a microprocessor, a processing cell element, a microcontroller, a FPGA, an embedded controller, or other processor. In an example where processor 305 is a microprocessor, it is capable of serial, parallel, fixed point, floating point, out-of-order, speculative, and/or transactional execution. Processor 305 may be based on any architecture, such as x86, IPF, XScale, or other architecture. MCH 320 is coupled between processor 305 and system memory 330. MCH 320 may also include controllers, like controller 345, for communicating both with processor 305 and system memory 330, as well as other devices, such as a video card.

System memory 330 includes any random access memory (RAM), such as a random access memory (RAM), such as a static RAM (SRAM) or dynamic RAM (DRAM), device. Unlike a non-volatile memory, a volatile RAM device does not usually store values, when no power is supplied to the device. Examples of common RAM devices include double-data rate (DDR) RAM, synchronous DRAM (SDRAM), non-synchronous DRAM, and extended data out DRAM (EDO RAM).

MCH 320 is coupled to interconnect controller hub (ICH) 340 through interface 335. Interface 335 is typically a controller hub link bus or other interface for coupling MCH 320 and ICH 340. ICH 340 includes controller 345 and power module 350. Coupled downstream from controller 345 is bridge 360. Device 370 is coupled to bridge 365 downstream from both controller 345 and bridge 365. Memory device/flash memory 375 and power source 355 is also shown coupled to ICH 340. A few exemplary embodiments are discussed below to illustrate removal of controller 345.

In a first example, assume that device 370 is a PCI-E device, bridge 365 is a PCI-E bridge for coupling devices in a hierarchy, and controller 345 is a PCI-E controller integrated in ICH 340. Device 370 is either gracefully or surprisingly removed from system 300. Detection module 365 is shown in bridge 360; however, detection module 365 may be present in controller 345 or have portions in bridge 360 and portions in controller 345. Detection module 365 is to determine if device 370 is present. Consequently, upon the removal, a detection module, which may share circuits/logic in controller 345, generates an interrupt to inform higher level modules that the device is no longer present downstream, as it has been removed from port 366 on bridge 360.

Code, such as handler code, stored in section 380 of flash memory device 375, is to handle the interrupt generated by controller 345/detection module 365. When the interrupt is generated/received a portion of code 380 is executed to request an operating system component/driver to stop controller 345 and/or request power module 350 to put controller 345 in a low-power state. Code 380 is executed by a processing element, when the interrupt is generated. In a first embodiment, an embedded controller in flash 375 executes the code. In another embodiment, code is executed by processor 305.

Here, requesting an operating system (OS) to stop controller 345 includes notifying/request a device manager associated with the OS to eject/stop controller 345 from OS visibility. As noted above, requesting the power module to place controller 345 in a low-power state includes either an interrupt request, a request forwarded from the OS, or other request. As a result, controller 345 is removed from visibility from an operating system level. Controller 345 is put in a low-power state to save power during its inactivity. Also stated above, the low power state may include gating all power, gating all clocks, gating all power except to detection module 365, enabling detection module periodically to see if device 370 is present, or reducing power to controller 345.

As a variation of the example above, assume that system 300 employs virtualization techniques. Consequently, VM 331 includes the operating system memory space. In this case, the memory device may be system memory 330 and the handler code includes a virtual machine monitor (VMM) to handle the interrupt instead of the BIOS code stored in flash 375.

### AN EMBODIMENT OF REMOVING A CONTROLLER

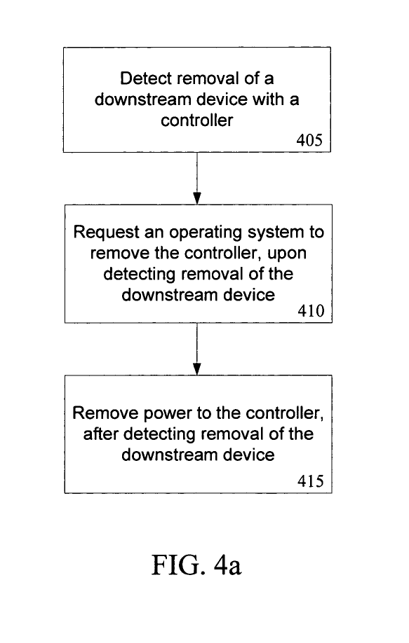

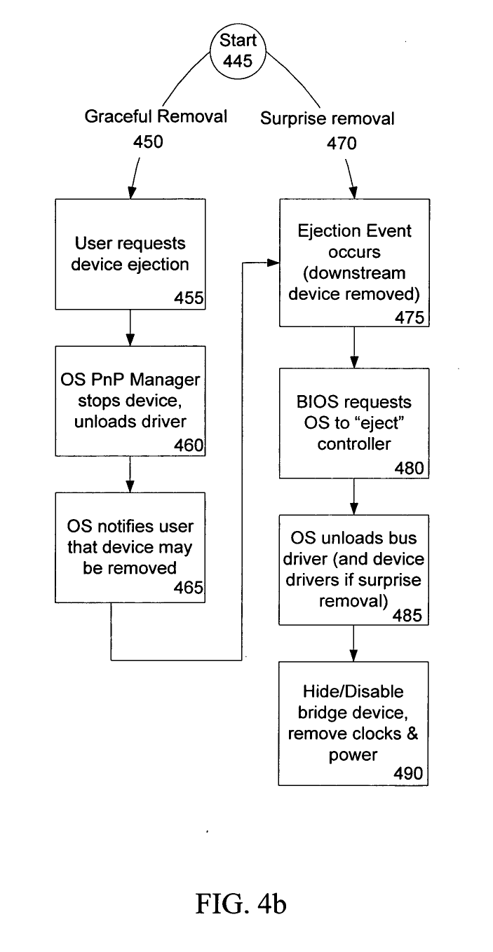

Turning to FIG. 4a, an embodiment of a flow diagram for a method of disabling a controller upon removal of a downstream device is illustrated. In flow 405, removal of a downstream device is detected with a controller. A controller includes any interface module for communicating with a downstream device. A device includes any internal or external device to be coupled to a system over an interface. As stated above, common examples of interfaces that are known today include PCI, PCI-E, USB, SATA, wireless interface, front-side bus (FSB), a memory interface, a video interface, and a network interface.

In one embodiment, circuitry in the controller is used to detect if a downstream device is present. A removal of an interconnect device is typically an asynchronous event, which may cause an asynchronous event that notifies circuitry in the controller that the device has been removed. Yet, in another example a synchronous polling scheme is used, where periodically devices are polled to ensure they are still present. As noted above, removal is not required to only include physically decoupling a device from a system

In flow 410, the controller is requested to be removed from an operating system, upon detecting removal of the downstream device. In one embodiment, removal of the downstream device from an operating system includes removing the device visibility of the operating system. As a first example, requesting removal includes generating an interrupt, such as a System Control Interrupt (SCI), representing that a device has been removed. In addition, a hardware tracking logic, software, firmware, or a combination thereof keeps track of multiple device coupled to one controller. As a result, an interrupt is potentially not generated, if other devices are still coupled to the controller. Essentially by generating the interrupt a request to the operating system to remove the device is sent.

As stated above, a handler such as a BIOS interrupt handler, a virtual machine monitor, a plug-n-play manager associated with the operating system, or the operating system itself receives the request/interrupt and removes the controller. The handler receives/intercepts the interrupt, and then also requests the operating system to remove the device. For example, a BIOS interrupt handler receives the interrupt and sends a request to a plug-n-play manager associated with the operating system to remove the device.

The downstream device is potentially removed in the same manner. Typically, the device is removed first, and after determining no devices are present downstream, the controller is requested to be removed and removed from the operating system.

In addition, once the controller is removed from view of the operating system and is inactive, power supplied to the controller is removed in flow 415. In one embodiment, power previously supplied to the controller is gated. Additionally, clocks previously provided to the controller is potentially gated as part of removing power. As a consequence, when no devices are connected downstream from the controller, power is saved by not keeping the controller powered on.

FIG. 4b illustrates an embodiment of a specific example of removing a controller from a system. In starting flow position 445, it assumed that the device is coupled to the controller and the system is in operation. In flow 450, a graceful removal of a device is initiated. Typically, a graceful removal is initiated by a user. As an example, assume the device is a USB storage device and the user, in a device manager in the operating system, requests to stop/eject the device in flow 455. In flow 460, the OS plug-n-play manager (PnP) stops the device and unloads any associated drivers. Next, the user is notified that the device may be removed in flow 465.

Returning to start position 445, instead of a graceful removal, surprise removal 470 is initiated. A surprise removal includes physically removing the device without notice to the operating system. For example, if a USB portable storage device is pulled out of the USB port without stopping it in the operating system, that action constitutes a surprise removal. Therefore, after flow 465 or surprise removal initiation 470, an ejection even occurs, i.e. a downstream device is physically removed in flow 475. In response to the ejection event, BIOS requests the OS to eject the controller upstream from the device in flow 480. Upon a request, the OS unloads any bus drivers associated with the controller in 485. If the removal was a surprise removal, not a graceful removal, and the device drivers have not been previously unloaded, the device drivers may also be unloaded in flow 485. In flow 490, the bridge device is hidden/disabled, and resources such as power and clocks are removed.

### AN EMBODIMENT OF ADDING A CONTROLLER

Turning next to FIG. 5a, an embodiment of a flow diagram for enabling/adding a controller is illustrated. In flow 405, a detection module is enabled to detect if a device is present downstream from a controller. Enabling a detection module includes enabling clocks and/or power to the detection module. Assuming a controller and a detection module is disabled, i.e. power and clocks are gated, then enabling a detection module includes providing clocks and power to the detection module. As stated above, the detection module may include logic or circuitry in the controller, in a controller hub, or external to either or both of the controller and the controller hub.

However, leaving the detection module enabled at all time requires power. Therefore, in a polled style interface, where the detection module polls devices to ensure they are still present, during the downtime the detection module is potentially disabled to save power. So, in decision flow 510 if no downstream device is present then the detection module is disabled in flow 515. Yet, periodically detection module is re-enabled in a return to flow 505, to check if a device has been attached. As an example, a USB controller is enabled and no USB device is present, so the detection module is disabled. However, in another time period, such as 100 ms, the detection module is re-enabled to once again see if a device has been attached while power was off to the detection module.

In contrast, if a downstream device is present, power to the controller is enabled, which may include no longer gating power or supplying power, in flow 520. Next, an OS is notified that the controller is newly installed in flow 525. Notification of a newly installed controller or device occurs in a similar manner to notifying an OS of device or controller being removed, such as an interrupt, handler, PnP manger, or other module discussed above.

Referring last to FIG. 5b, an embodiment of a flow diagram for enabling a controller upon detecting insertion of a device. In flow 550, an insertion event occurs, such as plugging in a mouse into a USB port. Assuming that the bridge/controller was previously disabled, the bridge device, such as a USB bridge, is enabled in flow 555. Similar to the operation above, a user-level program, such as an operating system, is notified of the new device, such as the mouse, as well as the bus itself and bridge device in flow 565. Finally, in flow 570, an operating system is notified of the presence of the controller/bridge and discovers/enumerates the devices beneath the controller.

### AN EMBODIMENT OF AN ARTICLE OF MANUFACTURE

As illustrated above, if devices are removed from a system, certain resources, such as power, are potentially wasted by applying power to a bus controller when no downstream devices are present. Therefore, by removing a controller from and operating system and removing power to the controller, resource may be efficiently allocated to other sections of an integrated circuit. In addition, detection circuitry in a controller is enabled periodically to determine if any devices have been inserted. Upon an insertion event, power may be restored to the controller and the controller, as well as the device, is added in an operating system through the aforementioned notification/enumeration procedures.

In the foregoing specification, a detailed description has been given with reference to specific exemplary embodiments. It will, however, be evident that various modifications and changes may be made thereto without departing from the broader spirit and scoped of the invention pended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a controller to communicate with a device;
a detection module associated with the controller to detect if the device is present;
a removal module coupled to the controller to request removal of the controller from a user-level program and to remove power from the controller, if the device is not present downstream.

2. The apparatus of claim 1, wherein the detection module includes circuitry in the controller to detect if the device is present.

3. The apparatus of claim 1, wherein the detection module includes a plug-and-play manager to detect that the device is not present upon a graceful removal of the device.

4. The apparatus of claim 1, wherein detection module includes logic to receive a signal from an external circuit, the signal representing that the device is not present.

5. The apparatus of claim 1, wherein the controller is selected from a group consisting of a peripheral connection interconnect (PCI) bus controller, a PCI express (PCI-E) bus controller, a universal serial bus controller, a disk controller, a long-term storage device controller, an ATA disk controller, a SCSI controller, a firewire controller, an audio controller, a video controller, a graphics controller, a network controller, a LAN controller, a memory interface controller, an interconnect controller, and a combination audio/video controller.

6. The apparatus of claim 5, wherein the controller is integrated in a controller hub.

7. The apparatus of claim 6, wherein the controller hub is at least a portion of a chipset.

8. The apparatus of claim 1, wherein the device is selected from a group consisting of a peripheral connection interconnect (PCI) device, a PCI express (PCI-E) device, a universal serial bus device, a storage drive, a permanent storage device, an ATA storage device, a SCSI device, a firewire device, an audio device, a video device, a graphics device, a network device, a LAN device, a memory device, and an interconnect device.

9. The apparatus of claim 1, wherein the user-level program is an operating system.

10. The apparatus of claim 1, wherein the user-level program is a virtual machine guest application.

11. The apparatus of claim 9, wherein requesting removal of the controller from the operating system includes generating an interrupt representing removal of the controller to be handled by an interrupt handler.

12. The apparatus of claim 11, wherein the interrupt handler is to notify a plug-and-play manager associated with the operating system that the controller is to be removed, upon receiving the interrupt.

13. The apparatus of claim 1, wherein removing power from the controller includes removing power from all logic in the controller except for logic associated with detection of a downstream device.

14. The apparatus of claim 1, wherein removing power from the controller includes removing power to the controller and gating clocks to the controller.

15. An apparatus comprising:
a detection module to determine if a device to be coupled downstream from a controller is removed, wherein the detection module, upon removal of the device, is also to generate a disconnect signal;
a handler module to receive the disconnect signal and to request ejection of the controller in an operating system based on the disconnect signal; and
a power module coupled to the detection module to remove power from the controller based on the disconnect signal.

16. The apparatus of claim 15, wherein detection module includes detection circuitry in the controller.

17. The apparatus of claim 16, wherein the handler module includes an interrupt handler.

18. The apparatus of claim 17, wherein code for the interrupt handler is included in basic input output software (BIOS) stored in a non-volatile memory device.

19. The apparatus of claim 18, wherein the interrupt handler requesting ejection of the controller in the operating system comprises notifying a plug and play (PnP) manager to stop the controller in the operating system.

20. The apparatus of claim 18, wherein removing power from the controller based on the disconnect signal includes gating power and clocks supplied to the controller, upon request of the software interrupt handler based on the disconnect signal.

21. A system comprising:
a controller hub including
a detection module to
determine if a device is present downstream from a controller in the controller hub, and
generate an interrupt if the device is not present downstream from the controller; and
a power module coupled to the detection module to place the controller in a low-power state, when requested.
a memory device coupled to the controller hub to store handler code that, when executed, is to
request an operating system to stop the controller, and
request the power module to put the controller in a low-power state; and
a processing element to execute the handler code, if the interrupt is generated.

22. The apparatus of claim 21, wherein the controller is selected from a group consisting of a peripheral connection interconnect (PCI) bus controller, a PCI express (PCI-E) bus controller, a universal serial bus controller, a disk controller, a long-term storage device controller, an ATA disk controller, a SCSI controller, a firewire controller, an audio controller, a video controller, a graphics controller, a network controller, a LAN controller, a memory interface controller, and an interconnect controller.

23. The system of claim 21, wherein controller hub is an interconnect controller hub (ICH).

24. The system of claim 21, wherein the device is not present downstream, when the device coupled to the controller and gracefully removed from the operating system.

25. The system of claim 21, wherein the memory device is a memory selected from a group consisting of a non-volatile memory device, a flash memory device, a random access memory (RAM), a static RAM (SRAM), and a dynamic RAM (DRAM).

26. The system of claim 21, wherein the memory device is a flash memory device, and wherein the handler code is basic input/output software (BIOS).

27. The system of claim 21, wherein the processing element is an x86 architecture processor, and wherein the operating system is executable on an x86 architecture.

28. The system of claim 21, wherein requesting the operating system to stop the controller comprises notifying a manager in the operating system that the controller has been removed.

29. The system of claim 21, wherein requesting the power module to remove power from the controller comprises sending a signal to the power module to represent the root controller is to enter the low-power state.

30. The system of claim 21, wherein the low-power state is a state where power is supplied to detection circuitry in the root controller.

31. The system of claim 21, wherein the low-power state is a state where no power is supplied to the root controller and no context for the root controller is stored.

32. A method comprising:
detecting removal of a downstream device with a controller;
requesting an operating system to remove the controller, upon detecting removal of the downstream device;
removing power to the controller, after detecting removal of the downstream device.

33. The method of claim 32, wherein circuitry in the controller detects removal of the downstream device.

34. The method of claim 33, wherein removing power to the controller comprises placing the controller in a low-power state.

35. The method of claim 34, wherein the low-power state includes a state where no power is supplied to the controller and no context is stored for the controller.

36. The method of claim 35, wherein the low-power state further includes gating clocks to the controller.

37. The method of claim 34, wherein the low-power state includes a state where power is retained for detection circuitry in the controller.

38. The method of claim 32, wherein requesting an operating system to remove the
controller comprises
generating a system control interrupt (SCI) to represent removal of the downstream device; and
requesting a manager in the operating system to eject the controller.

39. The method of claim 38, further comprising stopping the controller with the manager in the operating system.

40. The method of claim 39, wherein the manager is a plug-and-play (PnP) manager, and wherein the PnP manager ejects the controller using an advanced configuration and power interface (ACPI).

41. A method comprising:
enabling a detection module to detect if a device is present downstream from a controller;
disabling the detection module, if no downstream device is present;
if the downstream device is present,
enabling power to the controller; and
notifying an operating system that the controller is newly installed.

42. The method of claim 41, wherein the detection module includes circuitry in the controller to detect if a device is present downstream.

43. The method of claim 42, wherein the detection module further includes code that, when executed, is to determine if a device is present downstream.

44. The method of claim 43, wherein the code is part of a plug-and-play manager in the operating system.

45. The method of claim 41, wherein the detection module includes circuitry external to the controller to detect if a device is present downstream.

46. The method of claim 41, wherein enabling the detection module includes supplying power to the detection module, and wherein disabling the detection module comprises removing power from the detection module.

47. The method of claim 41, wherein notifying an operating system that the controller is newly installed comprises: transmitting a signal to a manager for the operating system representing that the controller is newly installed.

48. The method of claim 47, further comprising:
loading a first driver for the controller in the operating system;
loading a second driver for the device in the operating system.

49. An article of manufacture including program code which, when executed by a machine, causes the machine to perform the operations of:
requesting removal of a controller from visibility in a user-level program, if an interrupt, which represents that a device is not present downstream from the controller, is received;
requesting the controller be placed in a low-power state, after the controller is removed from visibility in the user-level program.

50. The method of claim 49, wherein the user-level program is an operating system, and wherein requesting removal of a controller from visibility in a user-level program comprises notifying a plug and play manager in the operating system that the device is not present.

51. The method of claim 49, wherein requesting the controller be placed in a low-power state includes generating an interrupt to place the controller in the low-power state.

52. The method of claim 51, wherein the low-power state is a state where power and clocks are gated.
